(19) United States
(12) Patent Application Publication
(10) Pub. No.: US 2019/0332765 A1
(43) Pub. Date: Oct. 31, 2019

(54) FILE PROCESSING METHOD AND SYSTEM, AND DATA PROCESSING METHOD

(71) Applicant: Alibaba Group Holding Limited, Grand Cayman (KY)

(72) Inventor: Yingfang Fu, Beijing (CN)

(21) Appl. No.: 16/388,734

(22) Filed: Apr. 18, 2019

(30) Foreign Application Priority Data
Apr. 28, 2018 (CN) 201810399221.9

(51) Int. Cl. G06F 21/52; G06F 21/56; G06F 21/72; G06F 21/31; G06F 21/45; H04L 9/32

(52) U.S. Cl. CPC G06F 21/52; G06F 21/561; G06F 21/566; G06F 2221/033; G06F 21/31; G06F 21/45; H04L 9/3268; G06F 21/72

(57) ABSTRACT

A file processing method including monitoring an operation request for operating a file; acquiring an operation feature of the operation if the operation request is monitored; and analyzing the operation feature, and determining to trigger a trusted chip to encrypt the file. The present disclosure solves the technical problems of low processing accuracy and high cost of the file processing method in the conventional techniques.

### CROSS REFERENCE TO RELATED PATENT APPLICATIONS

This application claims priority to Chinese Patent Application No. 201810399221.9 filed on 28 Apr. 2018 and entitled “FILE PROCESSING METHOD AND SYSTEM, AND DATA PROCESSING METHOD,” which is incorporated herein by reference in its entirety.

### TECHNICAL FIELD

The present disclosure relates to the field of computer security, and, more particularly, to file processing methods and systems, and data processing methods.

### BACKGROUND

Ransomware is a popular Trojan that may encrypt users' files to hold these files, so that data assets or computing resources of users cannot be used normally and money is extorted from the user. Once being infected with the ransomware, a prompt message usually pops up on a computer screen, indicating that the user's files are encrypted, and a ransom has to be paid. At this point, the user's key data may have been encrypted, and only the remote ransomer has the password.

In order to prevent data from being illegally encrypted or even prevent data from being extorted for money, a variety of solutions have been provided in the conventional techniques. In a real-time backup technology, when the ransomware holds a user's data, the user may restore to the latest backup, thus reducing the loss. However, this solution comes at the expense of a large amount of storage space. In a file access control technology, one or more document editors are used accordingly for each type of document, provided that only processes of these editors are allowed to modify and edit the documents. However, this solution requires the maintenance and management of a white list at a high cost. In a key recovery technology, as there may be loopholes and negligence when a ransomer extorts with the ransomware, e.g., forgetting to clear a file encryption key in the memory, the key remained in the memory may be found to recover the extorted data of the user. However, this solution severely relies on the loopholes during implementation of the ransomware. Moreover, in a binary detection technology, various types of files (including suspicious documents and unknown applications) are automatically submitted to a cloud platform and are authenticated centralized by feature detection, virtualized execution, and other methods, so that suspicious documents (probably attack documents having loophole exploitation) and malicious programs may be found in time. However, this technology cannot cope with new varieties.

At present, no effective solution has been proposed to solve the problems of low processing accuracy and high cost of the file processing method in the conventional techniques.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

File processing methods and systems, and data processing methods are provided in example embodiments of the present disclosure to at least solve the technical problems of low processing accuracy and high cost of the file processing method in the conventional techniques.

According to an example embodiment of the present disclosure, a file processing method is provided, comprising: monitoring an operation request for operating a file; acquiring an operation feature of the operation if the operation request is monitored; and analyzing the operation feature, and determining to trigger a trusted chip to encrypt the file.

According to another example embodiment of the present disclosure, a file processing system is further provided, comprising: a file trusted operation monitoring component configured to monitor an operation request for operating a file, and acquire an operation feature of the operation if the operation request is monitored; and a trusted chip configured to encrypt the file, wherein the file trusted operation monitoring component is in communication with the trusted chip and is further configured to analyze the operation feature and determine to trigger the trusted chip to encrypt the file.

According to another example embodiment of the present disclosure, one or more memories comprising a stored program or computer-readable instructions are further provided, wherein during running of the program, a computing device where the memory is located is controlled to perform the following steps: monitoring an operation request for operating a file; acquiring an operation feature of the operation if the operation request is monitored; and analyzing the operation feature, and determining to trigger a trusted chip to encrypt the file.

According to another example embodiment of the present disclosure, one or more processors for running a program or computer-readable instructions are further provided, wherein during running of the program, the following steps are performed: monitoring an operation request for operating a file; acquiring an operation feature of the operation if the operation request is monitored; and analyzing the operation feature, and determining to trigger a trusted chip to encrypt the file.

According to another example embodiment of the present disclosure, a file processing system is further provided, comprising: one or more processors; and memories connected to the processors and used to provide the processors with the computer-readable instructions for processing the following processing steps: monitoring an operation request for operating a file; acquiring an operation feature of the operation if the operation request is monitored; and analyzing the operation feature, and determining to trigger a trusted chip to encrypt the file.

According to another example embodiment of the present disclosure, a data processing method is further provided, comprising: acquiring an operation request for operating data, wherein the operation request includes an operation code; and determining, according to the operation code, to trigger a trusted chip to encrypt the data, wherein the operation code corresponds to an operation feature.

In the example embodiments of the present disclosure, an operation request for operating a file is monitored in real time. When the operation request is monitored, an operation feature of the operation is acquired. The operation feature is analyzed to determine to trigger a trusted chip to encrypt the file, thus achieving the objective of recognizing ransomware and preventing the ransomware from operating the file.

It is noted that only a valid user who encrypts a file through a trusted chip may overwrite or delete the file. Compared with the conventional techniques, files do not need to be backed up, thereby unnecessary to sacrifice a large amount of storage space to store backup files; moreover, it is unnecessary to maintain a large and comprehensive editor white list, and only a few valid users of operable files in a host need to be managed. In addition, new varieties of the ransomware are coped with, thus achieving the technical effects of saving storage space, reducing management costs, increasing the processing accuracy, and improving the user experience.

As such, the technical problems of low processing accuracy and high cost of the file processing method in the conventional techniques are solved by the solutions provided in the present disclosure.

### BRIEF DESCRIPTION OF THE DRAWINGS

The accompanying drawings are to enable further understanding for the present disclosure. The example embodiments of the present disclosure and illustrations thereof are used for explaining the present disclosure, rather than limiting the present disclosure improperly. In the accompanying drawings:

FIG. 1 is a schematic diagram of a file processing system according to Example embodiment 1 of the present disclosure;

FIG. 2 is a schematic architectural diagram of an optional file processing system according to an example embodiment of the present disclosure;

FIG. 3 is a flowchart of an optional file processing method according to an example embodiment of the present disclosure;

FIG. 4 is a hardware structural block diagram of a computer terminal (or a mobile device) for implementing a file processing method according to an example embodiment of the present disclosure;

FIG. 5 is a flowchart of a file processing method according to Example embodiment 2 of the present disclosure;

FIG. 6 is a schematic diagram of a file processing apparatus according to Example embodiment 3 of the present disclosure;

FIG. 7 is a flowchart of a data processing method according to Example embodiment 4 of the present disclosure;

FIG. 8 is a schematic diagram of a data processing apparatus according to Example embodiment 5 of the present disclosure; and

FIG. 9 is a structural block diagram of a computer terminal according to an example embodiment of the present disclosure.

### DETAILED DESCRIPTION

To enable those skilled in the art to better understand the solutions of the present disclosure, the technical solutions in example embodiments of the present disclosure will be described clearly and completely below with reference to the accompanying drawings. Apparently, the described example embodiments merely represent a part, rather than all, of the example embodiments of the present disclosure. All other example embodiments derived by those of ordinary skill in the art based on the example embodiments of the present disclosure without creative efforts should fall in the protection scope of the present disclosure.

It should be noted that, in the specification, claims and accompanying drawings of the present disclosure, terms such as “first” and “second” are used to distinguish similar objects, but are not necessarily used to describe a specific order or sequence. It should be understood that data used as such may be exchanged in appropriate cases, and thus the example embodiments of the present disclosure described here may be implemented in an order other than those shown or described here. Moreover, terms “include/comprise”, “have” and any variations thereof intend to cover non-exclusive inclusion. For example, processes, methods, systems, products or devices including a series of steps or units are not limited to the steps or units clearly listed, but may include other steps or units that are not clearly listed or inherent to the processes, methods, products or devices.

Firstly, some nouns or terms appearing during description of the example embodiments of the present disclosure are applicable to the following explanations:

Trusted chip: The trusted chip (Trusted Computing) is a trusted chip platform supported by hardware-based security modules, and is widely used in computing and communication systems, to improve the overall system security.

Trusted Platform Module (TPM): The TPM is a security chip capable of guaranteeing integrity and authenticity of data, and is forcibly bound to a computing platform physically.

Ransomware: The ransomware is a popular Trojan that may kidnap users' files by encrypting their files so that the users' data assets or computing resources cannot be used normally, and then extort money from the users. Mainstream ransomware generally operates files in two manners. One is directly encrypting and overwriting original files, and in this case, the files are barely recoverable without the key of the ransomer. The other is generating copy files by encryption and then deleting original files. Recovery is possible in this case.

Information entropy: Shannon used a thermodynamic concept for reference. An average information amount after exclusion of redundancy in the information may be referred to as an “information entropy”, and a mathematical expression for calculating the information entropy is also provided.

### EXAMPLE EMBODIMENT 1

In the related art, various file processing methods for preventing files from being illegally encrypted by ransomware or even extorted for money need to sacrifice a large amount of storage space, have high cost, severely depend on loopholes during implementation of the ransomware, and cannot cope with new varieties. Therefore, the file processing methods are low in processing accuracy and high in cost.

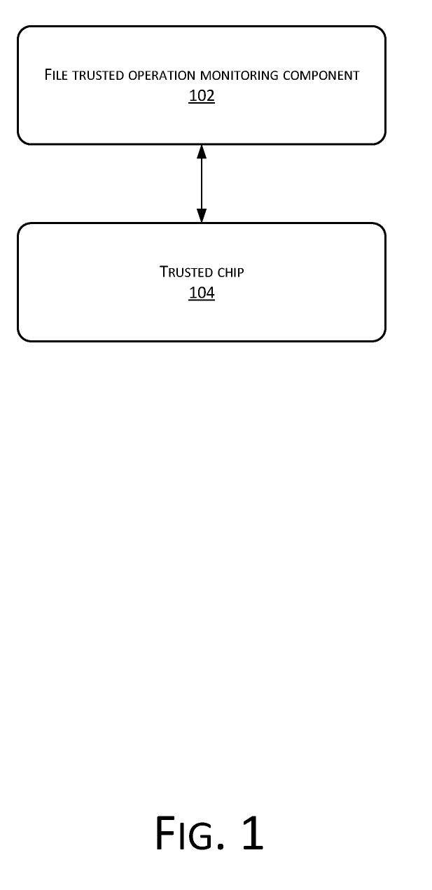

To solve the above technical problems, a file processing system is proposed in the present disclosure. FIG. 1 is a schematic diagram of a file processing system. As shown in FIG. 1, the system may include a file trusted operation monitoring component 102 and a trusted chip 104.

The file trusted operation monitoring component 102 is configured to monitor an operation request for operating a file, and acquire an operation feature of the operation if the operation request is monitored. The trusted chip 104 is configured to encrypt the file. The file trusted operation monitoring component 102 is in communication with the trusted chip 104 and is further configured to analyze the operation feature and determine to trigger the trusted chip 104 to encrypt the file.

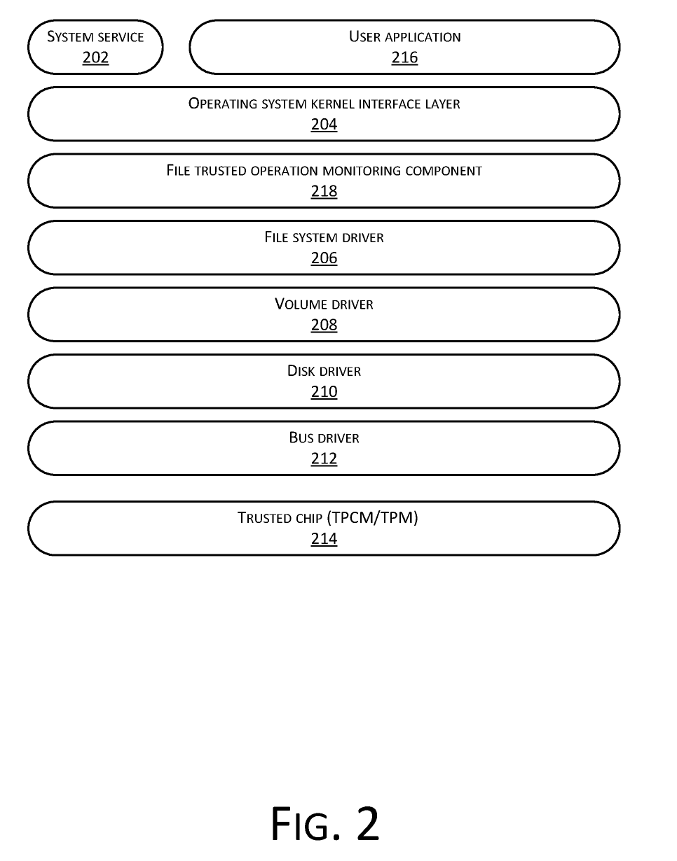

For example, as shown in FIG. 2, an operating system of a host having a Trusted Platform Control Module (TPCM) or a TPM trusted chip may include: a system service 202, an operating system kernel interface layer 204, a file system driver 206, a volume driver 208, a disk driver 210, a bus driver 212 and a trusted chip (TPCM/TPM) 214. The operating system performs data interaction with a user application 216 through the operating system kernel interface layer 204. The file trusted operation monitoring component 218 is added to the operating system kernel interface layer 204. The component is configured to intercept operation behaviors of all programs on files. The above host may be a mobile device such as a smart phone (including an Android phone and an IOS phone), a tablet computer, an IPAD, a palmtop computer or the like, or a computer device such as a PC computer, a notebook computer or the like, which is not specifically limited in the present disclosure. The above files may be sensitive files in the host that are not allowed to be modified or deleted by other users at will, or may be sensitive files that a user does not want other users to modify or delete at will. For example, for business users, the sensitive files may be contract files, customer information files, etc. The users will suffer huge losses if the above files are held by ransomware. The above operations may include a write operation and a read operation, and may include an encryption operation, an overwriting operation, a deletion operation, or the like, which is not specifically limited in the present disclosure. The specific type of operation may be defined according to actual processing requirements. Different operations have different operation features, and the operation feature may, for example, represent the type of the operation, whether to call the trusted chip to perform an operation, and the like.

It should be noted that, because the number of files stored in the host is large, it is possible to monitor only sensitive files instead of monitoring all files, thus improving the efficiency of file processing.

In an example solution, in a computer security protection application scenario, the file trusted operation monitoring component may be added in advance to the operating system kernel layer of the host having the TPCM or TPM trusted chip. The file trusted operation monitoring component intercepts operation requests for files, especially operations for sensitive files. That is, whenever the file trusted operation monitoring component monitors an operation request for operating a sensitive file, the file trusted operation monitoring component intercepts the operation request to prevent the operating system from responding to the operation request. After the file trusted operation monitoring component intercepts the operation, an operation feature of the operation may be acquired, and the operation feature is analyzed to determine whether the operation triggers the trusted chip to encrypt the file. If it is determined that the operation does not trigger the trusted chip, the operation may be determined as an invalid operation. In order to protect the sensitive file, the operation on the file may be prohibited, so that the operating system does not respond to this operation. If it is determined that the operation triggers the trusted chip, it may be determined that the operation is a valid operation by a valid user, and the operation on the file may be allowed, so that the file trusted operation monitoring component releases the intercepted operation request, and the operating system may respond to the operation and complete the corresponding operation.

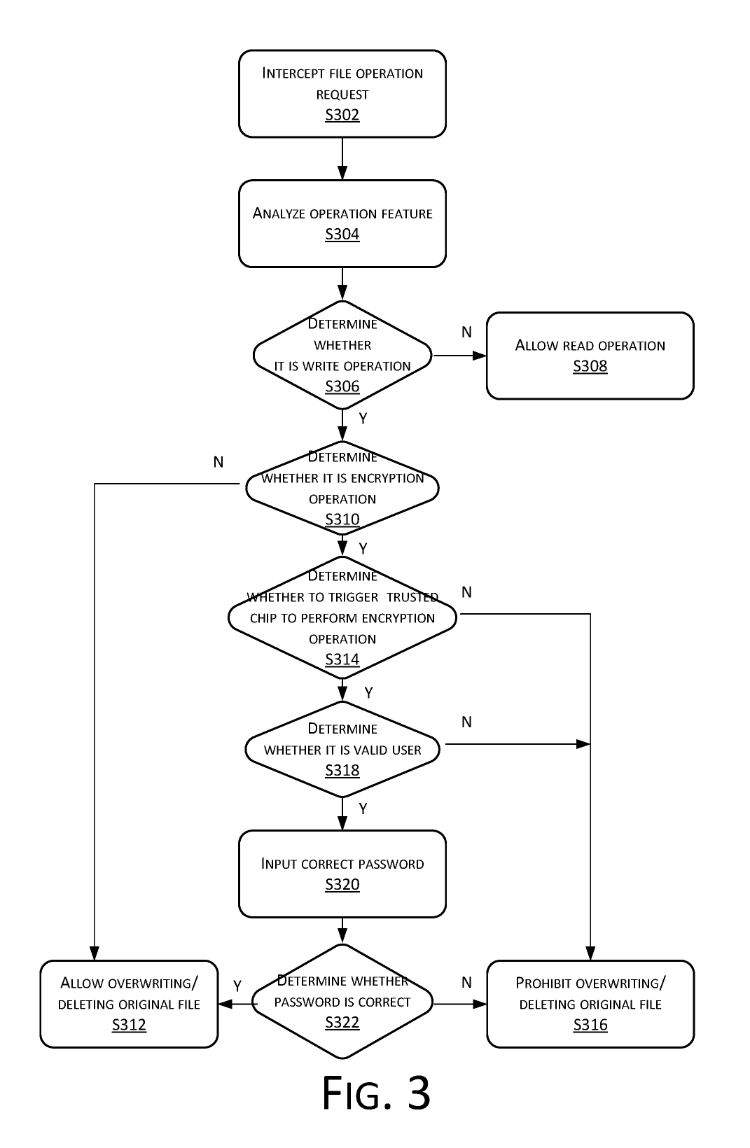

FIG. 3 is a flowchart of an optional file processing method according to an example embodiment of the present disclosure. A preferred example embodiment of the present disclosure is illustrated in detail below with reference to FIG. 3. As shown in FIG. 3, the method may include the following steps.

In step S302, a file operation request is intercepted.

For example, when a user operates a sensitive file and initiates an operation request, a file trusted operation monitoring component intercepts the operation request.

In step S304, an operation feature is analyzed.

For example, the file trusted operation monitoring component analyzes the operation feature of the operation request.

In step S306, whether the operation is a write operation is determined.

For example, the file trusted operation monitoring component determines, by analyzing the operation feature, whether the operation that the user needs to perform on the file is a write operation. If no, that is, the user needs to perform a read operation, step S308 is performed; and if yes, step S310 is performed.

In step S308, the read operation is allowed.

For example, after it is determined that the user needs to perform the read operation on the file, it may be determined that this operation is not an operation performed by ransomware. Therefore, the user may be allowed to perform the read operation on the file, and the file trusted operation monitoring component transmits the operation request back to an operating system kernel layer for response.

In step S310, whether the operation is an encryption operation is determined.

For example, after the user is determined to need to perform the write operation on the file, in order to prevent ransomware from operating on the file, whether the operation that the user needs to perform on the file is an encryption operation is further determined. For example, whether the operation is an encryption operation may be determined by determining whether an information entropy of a file overwriting an original file reaches an encryption threshold, or whether the content overwriting the original file conforms to an encryption feature by means of statistics, machine learning, and pattern recognition. If the operation is determined not an encryption operation, step S312 is perform; and if the operation is determined as an encryption operation, step S314 is performed.

In step S312, overwriting or deleting the original file is allowed.

For example, after the operation that the user needs to perform on the file is not an encryption operation is determined, this operation is determined not an operation performed by ransomware. Therefore, the user may be allowed to perform the overwriting operation or deletion operation on the file. That is, the user is allowed to overwrite/delete the original file, and the file trusted operation monitoring component transmits the operation request back to the operating system kernel layer for response.

In step S314, whether an encryption operation of the trusted chip is triggered is determined.

For example, after the user is determined to need to perform an encryption operation on the file, in order to prevent ransomware from operating the file, whether the user performs the encryption operation on the file by calling the trusted chip to acquire a file encryption key is further determined; if no, step S316 is performed; if yes, step S318 is performed.

In step S316, the original file is prevented from being overwritten/deleted.

For example, after the techniques of the present disclosure determine that the user performs the encryption operation on the file without calling the trusted chip to acquire the file encryption key, the techniques of the present disclosure determine that the operation may be an operation performed by ransomware, and the user may be prevented from performing an overwriting operation or a deletion operation on the file in order to protect the sensitive file of the user. That is, the user is prevented from overwriting/deleting the original file, and the file trusted operation monitoring component may ignore the operation request or directly discard the operation request, so that the operating system kernel layer cannot respond to the operation request.

In step S318, whether the user is a valid user is determined.

For example, after the techniques of the present disclosure determine that the user needs to perform the write operation on the file, in order to prevent an invalid user from operating the file, the techniques of the present disclosure determine whether the user is a valid user. If yes, step S320 is performed. If no, step S316 is performed again, and the techniques of the present disclosure determine that the operation is an operation performed by an invalid user. In order to protect the sensitive file of the user, the invalid user may be prevented from performing an overwriting operation or a deletion operation on the file, that is, the invalid user is prevented from overwriting/deleting the original file, and the file trusted operation monitoring component may ignore the operation request or directly discard the operation request, so that the operating system kernel layer cannot respond to the operation request.

It should be noted that the valid user needs to complete the following initialization:

Firstly, the valid user (referred to as C for short) and the file trusted operation monitoring component (referred to as S for short) acquire respective platform certificates Cert_AIKC and Cert_AIKS from a platform certificate issuing center (referred to as PCA for short) of a service server cluster. Respective platform public keys are AIKpk_C and AIKpk_S, respective platform private keys are AIKpriv_C and AIKpriv_S, and the respective platform private keys are stored in their respective TPCM/TPM chips. The PCA also has its own platform certificate Cert_AIKPCA, and platform identity public and private keys AIKpk_PCA and AIKpriv_PCA. Both C and S may acquire, from the PCA, a platform identity public key and a platform certificate of an object to be communicated with.

Next, C completes initialization registration with S to become a valid user, has a corresponding privileged password, and submits a list of files to be protected. C only intercepts operation requests for operating the files in the list of files to be protected. C may acquire a file encryption key of an encrypted file from the TPCM/TPM chip and store the key in the trusted chip.

It should also be noted that, in order that the user may view the encrypted file conveniently, C may acquire a file decryption key for decrypting the file from the TPCM/TPM chip and store the key in the trusted chip.

In step S320, a correct password is input.

For example, after it is determined that the user who needs to operate the file is a valid user, in order to ensure that the valid user performs a valid operation on the file, the file trusted operation monitoring component may allow the user to input a password, that is, input the privileged password owned by the valid user after registration.

In step S322, whether the password is correct is determined.

For example, the file trusted operation monitoring component determines whether the password input by the user is correct, that is, determines whether the password input by the user is the same as the privileged password owned by the valid user after registration. If the input password is the same as the privileged password, the techniques of the present disclosure determine that the password is correct, and step S312 may be performed. The techniques of the present disclosure determine that the operation is not an operation performed by ransomware. The user may be allowed to perform an overwriting operation or a deletion operation on the file, that is, the user is allowed to overwrite/delete the original file, and the file trusted operation monitoring component may transmit the operation request back to the operating system kernel layer for response. If the input password is different from the privileged password, the techniques of the present disclosure determine that the password is incorrect, and step S316 may be performed. In order to protect the sensitive file of the user, the user may be prevented from performing the overwriting operation or deletion operation on the file, that is, the user is prevented from overwriting/deleting the original file. The file trusted operation monitoring component may ignore the operation request or directly discard the operation request, so that the operating system kernel layer cannot respond to the operation request.

According to the solution provided in Example embodiment 1 of the present disclosure, an operation request for operating a file may be monitored in real time; an operation feature of the operation may be acquired when the operation request is monitored; the operation feature is analyzed, and it is determined to trigger a trusted chip to encrypt the file, thus achieving the purpose of identifying ransomware and preventing the ransomware from operating files.

It is noted that only a valid user who encrypts a file through a trusted chip may overwrite or delete the file. Compared with the conventional techniques, files do not need to be backed up, and therefore, it is unnecessary to sacrifice a large amount of storage space to store backup files; moreover, it is unnecessary to maintain a large and comprehensive editor white list, and only few valid users of operable files in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 1 provided in the present disclosure.

In the above example embodiment of the present disclosure, the file trusted operation monitoring component is further configured to determine whether to trigger the trusted chip to perform the encryption operation on the file, and the trusted chip is configured to encrypt or decrypt the file by a key stored therein. If the trusted chip is triggered to perform the encryption operation on the file, then it is determined to trigger the trusted chip to encrypt the file, and a step of allowing a valid operation by the valid user on the file is performed. If the trusted chip is not triggered to perform the encryption operation on the file, then it is determined that the trusted chip is not triggered to encrypt the file, and a step of prohibiting the valid operation on the file is performed.

For example, the above trusted chip may be the trusted chip as shown in FIG. 2, and an independent key for performing an encryption operation or decryption operation on the file is stored in the trusted chip. The trusted chip may be called and thus be triggered to encrypt the file independently, and perform the encryption operation, overwriting operation or deletion operation on the file. The valid user may be the owner of the file or a user with an operation privilege. Only the valid user is allowed to perform operations such as the encryption operation, overwriting operation or deletion operation on the sensitive file by triggering the trusted chip.

It should be noted that the essence of ransomware is that an invalid user encrypts a user's file by the ransomware, and overwrites the original file with the encrypted file, or deletes the original file. Therefore, only the valid user is allowed to perform operations such as the encryption operation, overwriting operation or deletion operation, i.e., perform a valid operation, on the file by calling the trusted chip to acquire the file encryption key.

In an example solution, as shown in step S314 to step S318 in FIG. 3, based on the essence of the ransomware, in order to prevent the ransomware from operating the file, the operation feature of the operation may be analyzed, and the techniques of the present disclosure determine whether the trusted chip is triggered to perform the encryption operation on the file, thereby determining whether to trigger the trusted chip to encrypt the file. If the techniques of the present disclosure determine that the trusted chip is triggered to perform the encryption operation on the file, the techniques of the present disclosure determine to trigger the trusted chip to encrypt the file, thereby allowing the valid user to perform the overwriting operation or deletion operation on the file, that is, allowing the user to overwrite/delete the original file. The file trusted operation monitoring component may transmit the operation request back to the operating system kernel layer for response. If the techniques of the present disclosure determine that the trusted chip is not triggered to perform the encryption operation on the file, the techniques of the present disclosure determine that the trusted chip is not triggered to encrypt the file, and the techniques of the present disclosure determine that this operation may be an operation performed by the ransomware. The user may be prevented from performing the overwriting operation or deletion operation on the file in order to protect the sensitive file of the user. That is, the user is prevented from overwriting/deleting the original file, and the file trusted operation monitoring component may ignore the operation request or directly discard the operation request, so that the operating system kernel layer cannot respond to the operation request.

It should be noted that after the trusted chip is triggered to encrypt the file, the file encryption key stored in the trusted chip is called to encrypt the file. In order to open the encrypted file, the trusted chip may be triggered to call a file decryption key in the trusted chip corresponding to the file encryption key, to decrypt the file.

In the above example embodiment of the present disclosure, the file trusted operation monitoring component is further configured to determine whether the operation feature of the operation is an encryption behavior before determining whether to trigger the trusted chip to encrypt the file, and if it is determined that the operation feature belongs to the encryption behavior, determine whether to trigger the trusted chip to encrypt the file.

In an example solution, as shown in step S310 and step S314 in FIG. 3, based on the essence of the ransomware, in order to prevent the ransomware from operating the file, it may be first determined whether the operation that the user needs to perform on the file is an encryption operation. After it is determined that the user needs to perform the encryption operation on the file, it may be further determined whether the user performs the encryption operation on the file by calling the trusted chip to acquire the file encryption key, thereby determining whether this operation is an operation performed by the ransomware.

In the above example embodiment of the present disclosure, the file trusted operation monitoring component is further configured to acquire an information entropy of a target file, determine whether the information entropy reaches an encryption threshold, determine that the operation feature belongs to the encryption behavior if the techniques of the present disclosure determine that the information entropy reaches the encryption threshold, and determine that the operation feature does not belong to the encryption behavior if the techniques of the present disclosure determine that the information entropy does not reach the encryption threshold, wherein the target file is a file used for overwriting the file.

For example, the above target file may be a file that will overwrite the original file, and the encryption threshold may be a standard value of the information entropy of the encrypted file.

In an example solution, in order to determine whether the user needs to perform the encryption operation on the file, the techniques of the present disclosure calculate whether the information entropy of the file that will overwrite the original file reaches the standard value of the information entropy of the encrypted file. If so, the techniques of the present disclosure determine that the file overwriting the original file is an encrypted file, that is, the techniques of the present disclosure determine that the user needs to perform the encryption operation on the file; otherwise, the techniques of the present disclosure determine that the user does not need to perform the encryption operation on the file.

In the above example embodiment of the present disclosure, the file trusted operation monitoring component is further configured to acquire target content, determine whether the target content conforms to an encryption feature, and determine that the operation feature belongs to the encryption behavior if determining that the target content conforms to the encryption feature, and determine that the operation feature does not belong to the encryption behavior if determining that the target content does not conform to the encryption feature, wherein the target content is content used for overwriting the file.

For example, the encryption feature may be a feature of content of the encrypted file.

In an example solution, in order to determine whether the user needs to perform the encryption operation on the file, the techniques of the present disclosure identify whether the content that will overwrite the original file conforms to the encryption feature by the method of statistics, machine learning, and mode recognition, and if yes, the techniques of the present disclosure determine that the file overwriting the original file is an encrypted file, that is, the techniques of the present disclosure determine that the user needs to perform the encryption operation on the file; otherwise, the techniques of the present disclosure determine that the user does not need to perform the encryption operation on the file.

In the above example embodiment of the present disclosure, the file trusted operation monitoring component is further configured to perform the step of allowing the valid operation on the file, if determining that the operation feature does not belong to the encryption behavior.

In an example solution, as shown in step S312 in FIG. 3, after the techniques of the present disclosure determine that the user does not need to perform the encryption operation on the file, the techniques of the present disclosure determine that this operation is not an operation performed by ransomware. Therefore, the user may be allowed to perform the overwriting operation or deletion operation on the file, that is, the user is allowed to overwrite/delete the original file, and the file trusted operation monitoring component may transmit the operation request back to the operating system kernel layer for response.

In the above example embodiment of the present disclosure, the processing apparatus is further configured to determine whether the operation is a write operation, determine whether the operation feature of the operation is an encryption behavior if the operation is determined as a write operation, and perform a step of allowing a read operation on the file if the operation is determined as the read operation.

In an example solution, as shown in step S306 to step S310 in FIG. 3, based on the essence of the ransomware, the file trusted operation monitoring component may determine, by analyzing the operation feature, whether the user needs to perform the write operation on the file. If yes, in order to prevent the ransomware from operating the file, it is necessary to further determine whether the write operation is an encryption operation. If no, that is, the user needs to perform the read operation on the file, and the techniques of the present disclosure determine that the operation is not an operation performed by the ransomware. Therefore, the user may be allowed to perform the read operation on the file, and the file trusted operation monitoring component transmits the operation request back to the operating system kernel layer for response.

In the above example embodiment of the present disclosure, the file trusted operation monitoring component is further configured to acquire a password input by a valid user, determine whether the password is correct, perform a step of allowing a valid operation by a valid user on the file if determining that the password is correct, and perform a step of prohibiting the valid operation on the file if it is determined that the password is incorrect.

In an example solution, as shown in step S320 and step S322 in FIG. 3, in order to ensure that a valid user performs a valid operation on the file, the file trusted operation monitoring component may allow the valid user to input a password, and determine whether the password input by the user is the same as the privileged password. If the input password is the same as the privileged password, the techniques of the present disclosure determine that the password is correct, and it may be determined that the operation is not an operation performed by the ransomware. The user may be allowed to perform the overwriting operation or deletion operation on the file, that is, the user is allowed to overwrite/delete the original file. The file trusted operation monitoring component may transmit the operation request back to the operating system kernel layer for response. If the input password is different from the privileged password, the techniques of the present disclosure determine that the password is incorrect, and in order to protect the sensitive file of the user, the user may be prevented from performing the overwriting operation or deletion operation on the file, that is, the user is prevented from overwriting/deleting the original file. The file trusted operation monitoring component may ignore the operation request or directly discard the operation request, so that the operating system kernel layer cannot respond to the operation request.

In the above example embodiment of the present disclosure, the processing apparatus is further configured to acquire a registration request from the valid user, generate the privileged password for the valid user, and receive a file list sent by the valid user, wherein the operation request is a request for operating a file in the file list.

For example, the file list may be a list of files to be protected, and is provided by the valid user.

In an example solution, the valid user needs to complete initialization and registration with the file trusted operation monitoring component, thereby becoming a valid user, having a corresponding privileged password, and submitting a list of files to be protected, wherein the file trusted operation monitoring component only intercepts operation requests for operating files in the file list to be protected.

It should be noted that the file trusted operation monitoring component may acquire a file encryption key of an encrypted file from the TPCM/TPM chip and store the key in the trusted chip.

In the above example embodiment of the present disclosure, the file trusted operation monitoring component is further configured to acquire platform certificates from a platform certificate issuing center, and store the platform certificates in the trusted chip, wherein the platform certificates include a platform certificate of the valid user and a platform certificate of the file trusted operation monitoring component.

For example, the platform certificate issuing center may be a platform certificate issuing center of a service server cluster, and store the platform certificates of the valid user and the file trusted operation monitoring component.

In an example solution, the valid user (referred to as C for short) and the file trusted operation monitoring component (referred to as S for short) acquire respective platform certificates Cert_AIKC and Cert_AIKS from a platform certificate issuing center (referred to as PCA for short) of a service server cluster. Respective platform public keys are AIKpk_C and AIKpk_S, respective platform private keys are AIKpriv_C and AIKpriv_S, and the respective platform private keys are stored in their respective TPCM/TPM chips. The PCA also has its own platform certificate Cert_AIKPCA, and platform identity public and private keys AIKpk_PCA and AIKpriv_PCA. Moreover, both C and S may acquire, from the PCA, a platform identity public key and platform certificate of an object to be communicated with.

### EXAMPLE EMBODIMENT 2

According to the example embodiments of the present disclosure, an example embodiment of a file processing method is further provided. It should be noted that the steps shown in the flowchart of the accompanying drawings may be executed in a computer system such as a set of computer executable instructions. Moreover, although a logical order is shown in the flowchart, in some cases the steps shown or described may be performed in an order different from that described here.

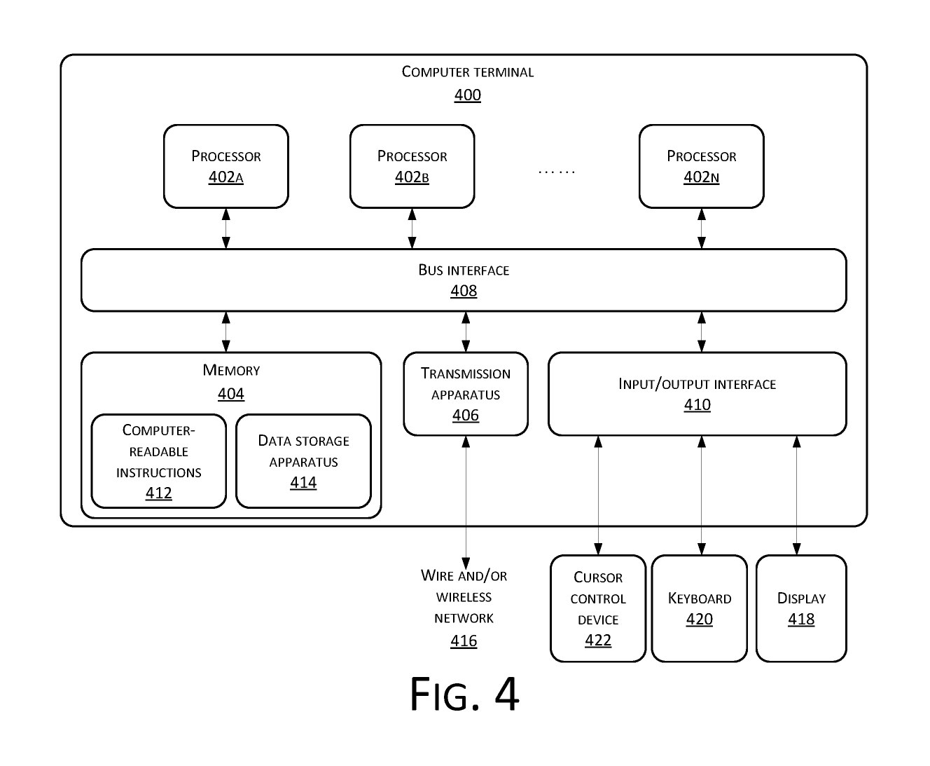

The method example embodiment provided in Example embodiment 1 of the present disclosure may be performed in a mobile terminal, a computer terminal or a similar computing apparatus. FIG. 4 is a hardware structural block diagram of a computer terminal (or mobile device) for implementing a file processing method. As shown in FIG. 4, a computer terminal 400 (such as a mobile device) may include one or more processors (shown as 402a, 402b, . . . , 402n in FIG. 4, wherein n may be any integer) (the processor(s) 402 may include, but is not limited to, a processing apparatus such as a micro processor (MCU) or a programmable logic device (FPGA)), a memory 404 configured to store data, and a transmission apparatus 406 for communication functions. In addition, the computer terminal 400 may also include: a bus interface 408, an input/output interface (I/O interface) 410. The bus interface 408 transmits data between the processor 402, the memory 404, the transmission apparatus 406, and the input/output interface 410. For example, a universal serial bus (USB) port may be included as one of the ports of the I/O interface 410. The computer terminal 400 may also include a network interface, a power supply and/or a camera (not shown in FIG. 4). It will be understood by those skilled in the art that the structure shown in FIG. 4 is merely illustrative and does not limit the structure of the above electronic device. For example, the computer terminal 400 may also include more or fewer components than those shown in FIG. 4, or have a configuration different from that shown in FIG.4.

It should be noted that the one or more processors 402 and/or other data processing circuits may generally be referred to as “data processing circuits” in this text. The data processing circuit may be embodied completely or partially as software, hardware, firmware or any other combination. Moreover, the data processing circuit may be a single, independent determining module, or incorporated completely or partially into any of other elements in the computer terminal 400 (or the mobile device). As referred to in the example embodiment of the present disclosure, the data processing circuit works as a processor to control, e.g., selection of a variable resistance terminal path connected to the interface.

The memory 404 may be configured to store software programs and modules of application software, such as computer-readable instructions 412 or data storage apparatus 414 corresponding to the file processing method in the example embodiment of the present disclosure. The processor 402 executes the software programs and modules stored in the memory 404, thus performing various functional applications and data processing, that is, implementing the file processing method. The memory 404 may include a high-speed random-access memory and may also include a non-volatile memory, such as one or more magnetic storage apparatuses, a flash memory, or other non-volatile solid-state memories. In some examples, the memory 404 may further include memories disposed remote to the processor 402. These remote memories may be connected to the computer terminal 400 over a network. Examples of the network include, but are not limited to, the Internet, an intranet, a local area network, a mobile communication network, and a combination thereof.

The transmission apparatus 406 is configured to receive or send data via a network. A specific example of the network may include a wire and/or wireless network 416 provided by a communication provider of the computer terminal 400. In one example, the transmission apparatus 406 includes a Network Interface Controller (NIC) that may be connected to other network devices through a base station to communicate with the Internet. In one example, the transmission apparatus 406 may be a Radio Frequency (RF) module for communicating with the Internet wirelessly.

The input/out interface interacts with one or more peripheral device such as a display 418, a keyboard 420, and a cursor control device 422 such as a mouse.

The display 418 may be, for example, a touch screen-type liquid crystal display (LCD) that allows a user to interact with a user interface of the computer terminal 400 (or the mobile device).

It should be noted here that, in some optional example embodiments, the computer device (or the mobile device) shown in FIG. 4 may include hardware elements (including circuits), software elements (including computer codes stored on a computer readable medium), or a combination of both hardware and software elements. It should be noted that FIG. 1 is only one example of a specific example embodiment, and is intended to show the types of components that may be present in the computer device (or the mobile device).

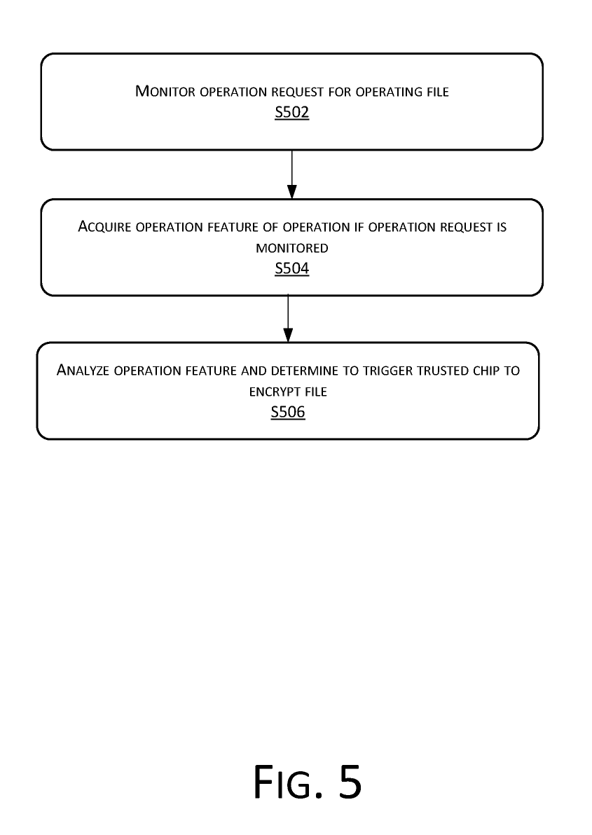

In the above operating environment, a file processing method as shown in FIG. 5 is provided in the present disclosure. FIG. 5 is a flowchart of a file processing method according to Example embodiment 2 of the present disclosure. As shown in FIG. 5, the method may include the following steps.

In step S502, an operation request for operating a file is monitored.

For example, a file trusted operation monitoring component may be added to an operating system kernel layer of a host having a TPCM or TPM trusted chip. The component is configured to intercept operation behaviors of all programs on files. The above host may be a mobile device such as a smart phone (including an Android phone and an IOS phone), a tablet computer, an IPAD, a palmtop computer or the like, or a computer device such as a PC computer, a notebook computer or the like, which is not specifically limited in the present disclosure. The above files may be sensitive files in the host that are not allowed to be modified or deleted by other users at will, or may be sensitive files that a user does not want other users to modify or delete at will. For example, for business users, the sensitive files may be contract files, customer information files, etc. The users will suffer huge losses if the above files are held by ransomware. The above operations may include a write operation and a read operation, and may, for example, include an encryption operation, an overwriting operation, a deletion operation or the like, which is not specifically limited in the present disclosure. The specific type of operation may be defined according to actual processing requirements.

In step S504, an operation feature of the operation is acquired if the operation request is monitored.

For example, different operations have different operation features, and the operation feature may represent the type of the operation, whether to call the trusted chip to perform an operation, and the like.

In step S506, the operation feature is analyzed, and it is determined to trigger the trusted chip to encrypt the file.

It should be noted that, because the number of files stored in the host is large, it is possible to monitor only sensitive files instead of monitoring all files, thus improving the efficiency of file processing.

In an example solution, in a computer security protection application scenario, the file trusted operation monitoring component may be added in advance to the operating system kernel layer of the host having the TPCM or TPM trusted chip. The file trusted operation monitoring component intercepts operation requests for files, especially operations for sensitive files. That is, whenever the file trusted operation monitoring component monitors an operation request for operating a sensitive file, the file trusted operation monitoring component intercepts the operation request to prevent the operating system from responding to the operation request. After the file trusted operation monitoring component intercepts the operation, an operation feature of the operation may be acquired, and the operation feature is analyzed to determine whether the operation triggers the trusted chip to encrypt the file. If it is determined that the operation does not trigger the trusted chip, the operation may be determined as an invalid operation. In order to protect the sensitive file, the operation on the file may be prohibited, so that the operating system does not respond to this operation. If it is determined that the operation triggers the trusted chip, it may be determined that the operation is a valid operation by a valid user, and the operation on the file may be allowed, so that the file trusted operation monitoring component releases the intercepted operation request, and the operating system may respond to the operation and complete the corresponding operation.

According to the solution provided in Example embodiment 2 of the present disclosure, an operation request for operating a file may be monitored in real time; an operation feature of the operation may be acquired when the operation request is monitored; the operation feature is analyzed, and it is determined to trigger a trusted chip to encrypt the file, thus achieving the purpose of identifying ransomware and preventing the ransomware from operating files.

It is noted that only a valid user who encrypts a file through a trusted chip may overwrite or delete the file. Compared with the conventional techniques, files do not need to be backed up, and therefore, it is unnecessary to sacrifice a large amount of storage space to store backup files; moreover, it is unnecessary to maintain a large and comprehensive editor white list, and only few valid users of operable files in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 2 provided in the present disclosure.

In the above example embodiment of the present disclosure, step S506 of analyzing the operation feature, and determining to trigger the trusted chip to encrypt the file may include the following step.

In step A, the techniques of the present disclosure determine whether to trigger the trusted chip to encrypt the file, wherein the trusted chip is configured to encrypt or decrypt the file by a key stored therein.

If the trusted chip is triggered to perform the encryption operation on the file, then it is determined to trigger the trusted chip to encrypt the file, and a step of allowing a valid operation by the valid user on the file is performed. If the trusted chip is not triggered to perform the encryption operation on the file, then it is determined that the trusted chip is not triggered to encrypt the file, and a step of prohibiting the valid operation on the file is performed.

For example, the above trusted chip may be the trusted chip as shown in FIG. 2, and an independent key for performing an encryption operation or decryption operation on the file is stored in the trusted chip. The trusted chip may be called and thus be triggered to encrypt the file, and perform the encryption operation, overwriting operation or deletion operation on the file. The valid user may be the owner of the file or a user with an operation privilege. Only the valid user is allowed to perform operations such as the encryption operation, overwriting operation or deletion operation on the sensitive file by triggering the trusted chip.

It should be noted that the essence of ransomware is that an invalid user encrypts a user's file by the ransomware, and overwrites the original file with the encrypted file, or deletes the original file. Therefore, only the valid user is allowed to perform operations such as the encryption operation, overwriting operation or deletion operation, i.e., perform a valid operation, on the file by calling the trusted chip to obtain the file encryption key.

In an example solution, as shown in step S314 to step S318 in FIG. 3, based on the essence of the ransomware, in order to prevent the ransomware from operating the file, the operation feature of the operation may be analyzed, and the techniques of the present disclosure determine whether the trusted chip is triggered to perform the encryption operation on the file, thereby determining whether to trigger the trusted chip to encrypt the file. If the techniques of the present disclosure determine that the trusted chip is triggered to perform the encryption operation on the file, the techniques of the present disclosure determine to trigger the trusted chip to encrypt the file, thereby allowing the valid user to perform the overwriting operation or deletion operation on the file, that is, allowing the user to overwrite/delete the original file. The file trusted operation monitoring component may transmit the operation request back to the operating system kernel layer for response. If determining that the trusted chip is not triggered to perform the encryption operation on the file, the techniques of the present disclosure determine that the trusted chip is not triggered to encrypt the file, and it may be determined that this operation may be an operation performed by the ransomware. The user may be prevented from performing the overwriting operation or deletion operation on the file in order to protect the sensitive file of the user. That is, the user is prevented from overwriting/deleting the original file, and the file trusted operation monitoring component may ignore the operation request or directly discard the operation request, so that the operating system kernel layer cannot respond to the operation request.

It should be noted that after the trusted chip is triggered to encrypt the file, the file encryption key stored in the trusted chip is called to encrypt the file. In order to open the encrypted file, the trusted chip may be triggered to call a file decryption key in the trusted chip corresponding to the file encryption key, to decrypt the file.

In the above example embodiment of the present disclosure, in step S506, before determining whether to trigger the trusted chip to encrypt the file, the method may further include the following steps.

In step B, the techniques of the present disclosure determine whether the operation feature of the operation is an encryption behavior.

In step C, the techniques of the present disclosure determine whether to trigger the trusted chip to encrypt the file if determining that the operation feature belongs to the encryption behavior.

In an example solution, as shown in step S310 and step S314 in FIG. 3, based on the essence of the ransomware, in order to prevent the ransomware from operating the file, it may be first determined whether the operation that the user needs to perform on the file is an encryption operation. After it is determined that the user needs to perform the encryption operation on the file, it may be further determined whether the user performs the encryption operation on the file by calling the trusted chip to acquire the file encryption key, thereby determining whether this operation is an operation performed by the ransomware.

In the above example embodiment of the present disclosure, step B of determining whether the operation feature of the operation is an encryption behavior may include the following steps.

In step B1, an information entropy of a target file is acquired, wherein the target file is a file used for overwriting the file.

For example, the above target file may be a file that will overwrite the original file.

In step B2, the techniques of the present disclosure determine whether the information entropy reaches an encryption threshold.

For example, the encryption threshold may be a standard value of the information entropy of the encrypted file.

In step B3, the techniques of the present disclosure determine that the operation feature belongs to the encryption behavior if it is determined that the information entropy reaches the encryption threshold.

In step B4, the techniques of the present disclosure determine that the operation feature does not belong to the encryption behavior if it is determined that the information entropy does not reach the encryption threshold.

In an example solution, in order to determine whether the user needs to perform the encryption operation on the file, the techniques of the present disclosure calculate whether the information entropy of the file that will overwrite the original file reaches the standard value of the information entropy of the encrypted file. If so, the techniques of the present disclosure determine that the file overwriting the original file is an encrypted file, that is, the techniques of the present disclosure determine that the user needs to perform the encryption operation on the file; otherwise, it may be determined that the user does not need to perform the encryption operation on the file.

In the above example embodiment of the present disclosure, step B of determining whether the operation feature of the operation is an encryption behavior may include the following steps.

In step B5, target content is acquired, wherein the target content is content used for overwriting the file.

In step B6, the techniques of the present disclosure determine whether the target content conforms to an encryption feature.

For example, the encryption feature may be a feature of content of the encrypted file.

In step B7, the techniques of the present disclosure determine that the operation feature belongs to the encryption behavior if determining that the target content conforms to the encryption feature.

In step B8, the techniques of the present disclosure determine that the operation feature does not belong to the encryption behavior if determining that the target content does not conform to the encryption feature.

In an example solution, in order to determine whether the user needs to perform the encryption operation on the file, the techniques of the present disclosure identify whether the content that will overwrite the original file conforms to the encryption feature by the method of statistics, machine learning, and mode recognition, and if yes, the techniques of the present disclosure determine that the file overwriting the original file is an encrypted file, that is, the techniques of the present disclosure determine that the user needs to perform the encryption operation on the file; otherwise, the techniques of the present disclosure determine that the user does not need to perform the encryption operation on the file.

In the above example embodiment of the present disclosure, when the techniques of the present disclosure determine that the operation feature does not belong to the encryption behavior, the step of allowing the valid operation on the file is performed.

In an example solution, as shown in step S312 in FIG. 3, after determining that the user does not need to perform the encryption operation on the file, the techniques of the present disclosure determine that this operation is not an operation performed by ransomware. Therefore, the user may be allowed to perform the overwriting operation or deletion operation on the file, that is, the user is allowed to overwrite/delete the original file, and the file trusted operation monitoring component may transmit the operation request back to the operating system kernel layer for response.

In the above example embodiment of the present disclosure, in step B, before determining whether the operation feature of the operation is an encryption behavior, the method may further include the following steps.

In step D, the techniques of the present disclosure determine whether the operation is a write operation.

In step E, the techniques of the present disclosure determine whether the operation feature of the operation is the encryption behavior if the operation is determined as the write operation.

In step F, the step of allowing a read operation on the file is performed if the operation is determined as the read operation.

In an example solution, as shown in step S306 to step S310 in FIG. 3, based on the essence of the ransomware, the file trusted operation monitoring component may determine, by analyzing the operation feature, whether the user needs to perform the write operation on the file. If yes, in order to prevent the ransomware from operating the file, it is necessary to further determine whether the write operation is an encryption operation. If no, that is, the user needs to perform the read operation on the file, the techniques of the present disclosure determine that the operation is not an operation performed by the ransomware, and therefore, the user may be allowed to perform the read operation on the file, and the file trusted operation monitoring component transmits the operation request back to the operating system kernel layer for response.

In the above example embodiment of the present disclosure, before step F of allowing the valid operation by the valid user on the file, the method may further include the following steps.

In step G, a password input by the valid user is acquired.

In step H, the techniques of the present disclosure determine whether the password is correct.

In step I, the step of allowing a valid operation by a valid user on the file is performed if determining that the password is correct.

In step J, the step of prohibiting the valid operation on the file is performed if determining that the password is incorrect.

In an example solution, as shown in step S320 and step S322 in FIG. 3, in order to ensure that a valid user performs a valid operation on the file, the file trusted operation monitoring component may allow the valid user to input a password, and determine whether the password input by the user is the same as the privileged password. If the input password is the same as the privileged password, the techniques of the present disclosure determine that the password is correct, and the techniques of the present disclosure determine that the operation is not an operation performed by the ransomware. The user may be allowed to perform the overwriting operation or deletion operation on the file, that is, the user is allowed to overwrite/delete the original file. The file trusted operation monitoring component may transmit the operation request back to the operating system kernel layer for response. If the input password is different from the privileged password, the techniques of the present disclosure determine that the password is incorrect, and in order to protect the sensitive file of the user, the user may be prevented from performing the overwriting operation or deletion operation on the file, that is, the user is prevented from overwriting/deleting the original file. The file trusted operation monitoring component may ignore the operation request or directly discard the operation request, so that the operating system kernel layer cannot respond to the operation request.

In the above example embodiment of the present disclosure, before step G of acquiring a password input by the valid user, the method may further include the following steps.

In step K, a registration request from the valid user is acquired.

In step L, a privileged password for the valid user is generated.

In step M, a file list sent by the valid user is received, wherein the operation request is a request for operating a file in the file list.

For example, the file list may be a list of files to be protected, and is provided by the valid user.

In an example solution, the valid user needs to complete initialization and registration with the file trusted operation monitoring component, thereby becoming a valid user, having a corresponding privileged password, and submitting a list of files to be protected, wherein the file trusted operation monitoring component only intercepts operation requests for operating files in the file list to be protected.

It should be noted that the file trusted operation monitoring component may acquire a file encryption key of an encrypted file from the TPCM/TPM chip and store the key in the trusted chip.

In the above example embodiment of the present disclosure, before step K of acquiring a registration request from the valid user, the method may further include the following steps.

In step N, platform certificates are acquired from a platform certificate issuing center, wherein the platform certificates include a platform certificate of the valid user and a platform certificate of the file trusted operation monitoring component.

For example, the platform certificate issuing center may be a platform certificate issuing center of a service server cluster, and store the platform certificates of the valid user and the file trusted operation monitoring component.

In step O, the platform certificates are stored in the trusted chip.

In an example solution, the valid user (referred to as C for short) and the file trusted operation monitoring component (referred to as S for short) acquire respective platform certificates Cert_AIKC and Cert_AIKS from a platform certificate issuing center (referred to as PCA for short) of a service server cluster. Respective platform public keys are AIKpk_C and AIKpk_S, respective platform private keys are AIKpriv_C and AIKpriv_S, and the respective platform private keys are stored in their respective TPCM/TPM chips. The PCA also has its own platform certificate Cert_AIKPCA, and platform identity public and private keys AIKpk_PCA and AIKpriv_PCA. Moreover, both C and S may acquire, from the PCA, the platform identity public key and platform certificate of an object to be communicated with.

It should be noted that, for ease of description, the foregoing method example embodiments are all expressed as a series of action combinations, but those skilled in the art should understand that the present disclosure is not limited by the described action sequence, because certain steps may be performed in other sequences or concurrently according to the present disclosure. Next, those skilled in the art should also understand that the example embodiments described in the specification are all preferred example embodiments, and the actions and modules involved are not necessarily mandatory to the present disclosure.

Through the description of the above example embodiments, those skilled in the art may clearly understand that the method according to the above example embodiment may be implemented by means of software plus a necessary general hardware platform, and certainly may also be implemented by hardware, but the former is the better implementation in many cases. Based on such understanding, the technical solution of the present disclosure essentially or the parts contributing to the conventional techniques may be embodied in the form of a software product. The computer software product is stored in a storage medium (such as a ROM/RAM, a magnetic disk, and an optical disc) and includes several instructions for enabling a terminal device (which may be a mobile phone, a computer, a server, a network device, or the like) to perform the methods described in various example embodiments of the present disclosure.

### EXAMPLE EMBODIMENT 3

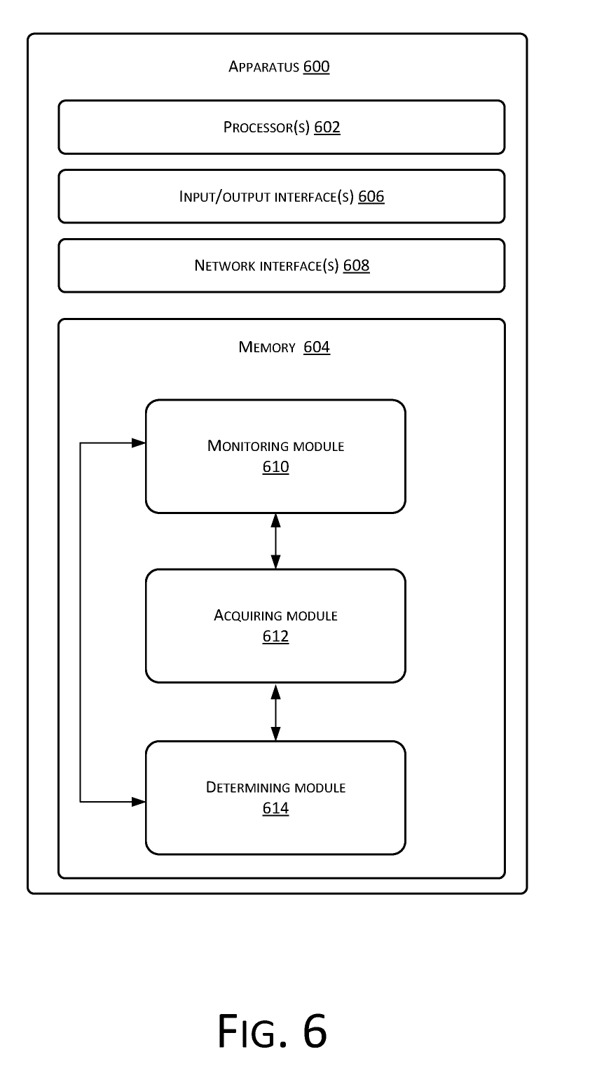

According to the example embodiments of the present disclosure, a file processing apparatus for implementing the above file processing method is further provided. As shown in FIG. 6, an apparatus 600 includes one or more processor(s) 602 or data processing unit(s) and memory 604. The apparatus 600 may further include one or more input/output interface(s) 606 and one or more network interface(s) 608. The memory 604 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 604 may store therein a plurality of modules or units including a monitoring module 610, an acquiring module 612, and a determining module 614.

The monitoring module 610 is configured to monitor an operation request for operating a file. The acquiring module 612 is configured to acquire an operation feature of the operation if the operation request is monitored. The determining module 614 is configured to analyze the operation feature, and determine to trigger a trusted chip to encrypt the file.

For example, a file trusted operation monitoring component may be added to an operating system kernel layer of a host having a TPCM or TPM trusted chip. The component is configured to intercept operation behaviors of all programs on files. The above host may be a mobile device such as a smart phone (including an Android phone and an IOS phone), a tablet computer, an IPAD, a palmtop computer or the like, or a computer device such as a PC computer, a notebook computer or the like, which is not specifically limited in the present disclosure. The above files may be sensitive files in the host that are not allowed to be modified or deleted by other users at will, or may be sensitive files that a user does not want other users to modify or delete at will. For example, for business users, the sensitive files may be contract files, customer information files, etc. The users will suffer huge losses if the above files are held by ransomware. The above operations may include a write operation and a read operation, and may, for example, include an encryption operation, an overwriting operation, a deletion operation or the like, which is not specifically limited in the present disclosure. The specific type of operation may be defined according to actual processing requirements. Different operations have different operation features, and the operation feature may, for example, represent the type of the operation, whether to call the trusted chip to perform an operation, and the like.

It should be noted that the monitoring module 610, the acquiring module 612, and the determining module 614 correspond to steps S502 to S506 in Example embodiment 2, and examples and application scenarios implemented by the three modules and the corresponding steps are the same, but are not limited to the content disclosed in Example embodiment 2. It should be noted that the above modules may be operated as a part of the apparatus in the computer terminal 400.

According to the solution provided in Example embodiment 3 of the present disclosure, an operation request for operating a file may be monitored in real time; an operation feature of the operation may be acquired when the operation request is monitored; the operation feature is analyzed, and it is determined to trigger a trusted chip to encrypt the file, thus achieving the purpose of identifying ransomware and preventing the ransomware from operating files.

It is noted that only a valid user who encrypts a file through a trusted chip may overwrite or delete the file. Compared with the conventional techniques, files do not need to be backed up, and therefore, it is unnecessary to sacrifice a large amount of storage space to store backup files; moreover, it is unnecessary to maintain a large and comprehensive editor white list, and only few valid users of operable files in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 3 provided in the present disclosure.

In the above example embodiment of the present disclosure, a determining module is further configured to determine whether to trigger the trusted chip to perform the encryption operation on the file, wherein the trusted chip is configured to encrypt or decrypt the file by a key stored therein. An executing module is further configured to, if the trusted chip is triggered to perform the encryption operation on the file, determine to trigger the trusted chip to encrypt the file, and perform a step of allowing a valid operation by the valid user on the file; and if the trusted chip is not triggered to perform the encryption operation on the file, determine that the trusted chip is not triggered to encrypt the file, and perform a step of prohibiting the valid operation on the file.

In the above example embodiment of the present disclosure, the determining module is further configured to determine whether the operation feature of the operation is an encryption behavior, and determine whether to trigger the trusted chip to encrypt the file if it is determined that the operation feature belongs to the encryption behavior.

In the above example embodiment of the present disclosure, the determining module includes an acquiring unit, a determining unit, and a determining unit.

The acquiring unit is configured to acquire an information entropy of a target file, wherein the target file is a file used for overwriting the file. The determining unit is configured to determine whether the information entropy reaches an encryption threshold. The determining unit is configured to determine that the operation feature belongs to the encryption behavior if it is determined that the information entropy reaches the encryption threshold, and determine that the operation feature does not belong to the encryption behavior if it is determined that the information entropy does not reach the encryption threshold.

In the above example embodiment of the present disclosure, the determining module includes an acquiring unit, a determining unit, and a determining unit.

The acquiring unit is configured to acquire target content, wherein the target content is content used for overwriting the file. The determining unit is configured to determine whether the target content conforms to an encryption feature. The determining unit is configured to determine that the operation feature belongs to the encryption behavior if it is determined that the target content conforms to the encryption feature, and determine that the operation feature does not belong to the encryption behavior if it is determined that the target content does not conform to the encryption feature.

In the above example embodiment of the present disclosure, the executing module is further configured to perform the step of allowing the valid operation on the file, when it is determined that the operation feature does not belong to the encryption behavior.

In the above example embodiment of the present disclosure, the determining module is further configured to determine whether the operation is a write operation, and determine whether to trigger the trusted chip to encrypt the file if the operation is determined as a write operation. The executing module is further configured to perform the step of allowing a read operation on the file if the operation is determined as the read operation.

In the above example embodiment of the present disclosure, the acquiring module is further configured to acquire a password input by a valid user. The determining module is configured to determine whether the password is correct. The executing module is further configured to perform the step of allowing a valid operation by a valid user on the file if it is determined that the password is correct, and perform the step of prohibiting the valid operation on the file if it is determined that the password is incorrect.

In the above example embodiment of the present disclosure, the apparatus further includes a generating module and a receiving module.

The acquiring module is further configured to acquire a registration request from the valid user. The generating module is configured to generate a privileged password of the valid use. The receiving module is configured to receive a file list sent by the valid user, wherein the operation request is a request for operating a file in the file list.

In the above example embodiment of the present disclosure, the apparatus further includes a storage module.

The acquiring module is further configured to acquire platform certificates from a platform certificate issuing center, wherein the platform certificates include a platform certificate of the valid user and a platform certificate of the file trusted operation monitoring component. The storage module is further configured to store the platform certificates in the trusted chip.

### EXAMPLE EMBODIMENT 4

According to the example embodiments of the present disclosure, an example embodiment of a data processing method is further provided. It should be noted that the steps shown in the flowchart of the accompanying drawings may be executed in a computer system such as a set of computer executable instructions. Moreover, although a logical order is shown in the flowchart, in some cases the steps shown or described may be performed in an order different from that described here.

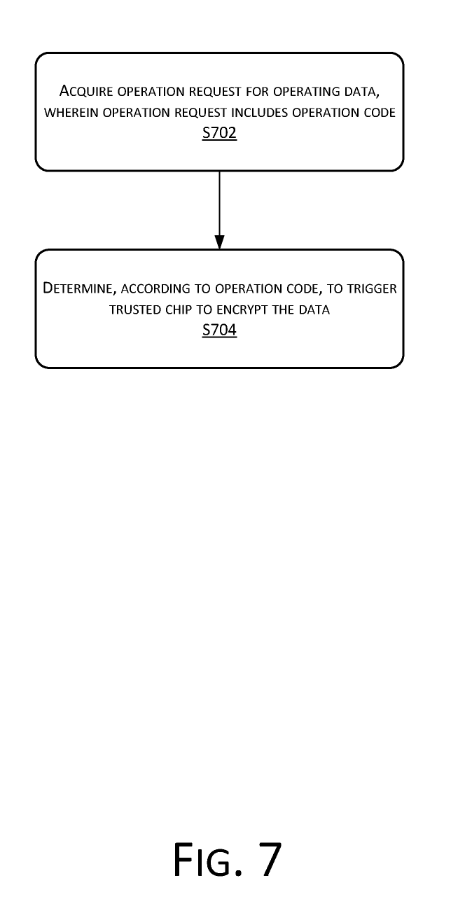

FIG. 7 is a flowchart of a data processing method according to Example embodiment 4 of the present disclosure. As shown in FIG. 7, the method may include the following steps.

In step S702, an operation request for operating data is acquired, wherein the operation request includes an operation code.

For example, a file trusted operation monitoring component may be added to an operating system kernel layer of a host having a TPCM or TPM trusted chip. The component is configured to intercept operation behaviors of all programs on files. The above host may be a mobile device such as a smart phone (including an Android phone and an IOS phone), a tablet computer, an IPAD, a palmtop computer or the like, or a computer device such as a PC computer, a notebook computer or the like, which is not specifically limited in the present disclosure. The above data may be data in sensitive files stored in the host that are not allowed to be modified or deleted by other users at will, or may be data in sensitive files that a user does not want other users to modify or delete at will. For example, for business users, the sensitive files may be data in contract files, customer information files, etc. The users will suffer huge losses if the above files are held by ransomware and thus the data cannot be read, or the data is tampered to cause data errors. The above operations may include a write operation and a read operation, and may, for example, include an encryption operation, an overwriting operation, a deletion operation or the like, which is not specifically limited in the present disclosure. The specific type of operation may be defined according to actual processing requirements. Each type of operation in the operating system corresponds to an operation code. After receiving the operation request, the operating system may determine which type of operation the user needs to perform on the data according to the operation code included in the operation request.

In step S704, it is determined, according to the operation code, to trigger a trusted chip to encrypt the data, wherein the operation code corresponds to an operation feature.

For example, different operations have different operation features, and the operation feature may represent the type of the operation, whether to call the trusted chip to perform an operation, or the like. The corresponding operation feature may be determined according to the operation code in the operation request, and it may be further determined which type of operation is required.

It should be noted that the data may be data stored in the file, and the operation on the data may be performed on the file. In the example embodiment of the present disclosure, the operation performed on the file is taken as an example for description. Because the number of files stored in the host is large, it is possible to monitor only sensitive files instead of monitoring all files, thus improving the efficiency of file processing.

In an example solution, in a computer security protection application scenario, the file trusted operation monitoring component may be added in advance to the operating system kernel layer of the host having the TPCM or TPM trusted chip. The file trusted operation monitoring component intercepts operation requests for files, especially operations for sensitive files. That is, whenever the file trusted operation monitoring component monitors an operation request for operating a sensitive file, the file trusted operation monitoring component intercepts the operation request to prevent the operating system from responding to the operation request. After the file trusted operation monitoring component intercepts the operation, an operation feature of the operation may be acquired, and the operation feature is analyzed to determine whether the operation triggers the trusted chip to encrypt the file. If it is determined that the operation does not trigger the trusted chip, the operation may be determined as an invalid operation. In order to protect the sensitive file, the operation on the file may be prohibited, so that the operating system does not respond to this operation. If it is determined that the operation triggers the trusted chip, it may be determined that the operation is a valid operation by a valid user, and the operation on the file may be allowed, so that the file trusted operation monitoring component releases the intercepted operation request, and the operating system may respond to the operation and complete the corresponding operation.

According to the solution provided in Example embodiment 4 of the present disclosure, an operation request for operating data may be acquired in real time; after the operation request is acquired, an operation code in the operation request may be extracted, and it may be determined, according to the operation code, to trigger a trusted chip to encrypt a file, thus achieving the purpose of identifying ransomware and preventing the ransomware from operating data.

It is noted that only a valid user who encrypts data through a trusted chip may overwrite or delete the data. Compared with the conventional techniques, data does not need to be backed up, and therefore, it is unnecessary to sacrifice a large amount of storage space to store backup data; moreover, it is unnecessary to maintain a large and comprehensive editor white list, and only few valid users of operable data in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 4 provided in the present disclosure.

### EXAMPLE EMBODIMENT 5

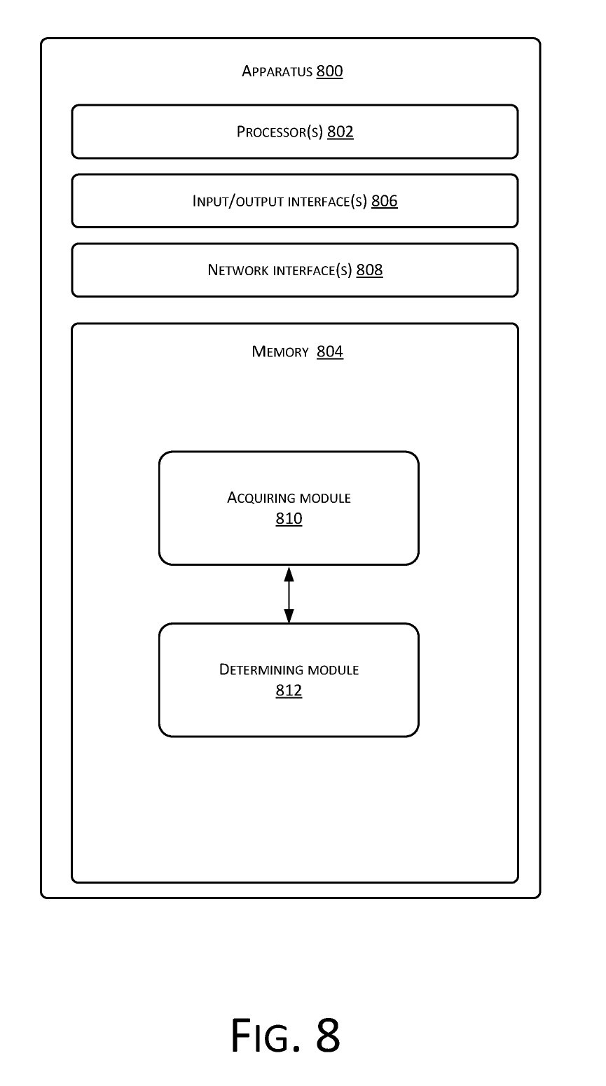

According to the example embodiments of the present disclosure, a file processing apparatus for implementing the above data processing method is further provided. As shown in FIG. 8, an apparatus 800 includes one or more processor(s) 802 or data processing unit(s) and memory 804. The apparatus 800 may further include one or more input/output interface(s) 806 and one or more network interface(s) 808. The memory 804 is an example of computer readable medium or media.

The memory 804 may store therein a plurality of modules or units including an acquiring module 810 and a determining module 812.

The acquiring module 810 is configured to acquire an operation request for operating data, wherein the operation request includes an operation code. The determining module 812 is configured to determine, according to the operation code, to trigger a trusted chip to encrypt the data, wherein the operation code corresponds to an operation feature.

For example, a file trusted operation monitoring component may be added to an operating system kernel layer of a host having a TPCM or TPM trusted chip. The component is configured to intercept operation behaviors of all programs on files. The above host may be a mobile device such as a smart phone (including an Android phone and an IOS phone), a tablet computer, an IPAD, a palmtop computer or the like, or a computer device such as a PC computer, a notebook computer or the like, which is not specifically limited in the present disclosure. The above data may be data in sensitive files stored in the host that are not allowed to be modified or deleted by other users at will, or may be data in sensitive files that a user does not want other users to modify or change at will. For example, for business users, the sensitive files may be data in contract files, customer information files, etc. The users will suffer huge losses if the above files are held by ransomware and thus the data cannot be read, or the data is tampered to cause data errors. The above operations may include a write operation and a read operation, and may, for example, include an encryption operation, an overwriting operation, a deletion operation or the like, which is not specifically limited in the present disclosure. The specific type of operation may be defined according to actual processing requirements. Each type of operation in the operating system corresponds to an operation code. After receiving the operation request, the operating system may determine which type of operation the user needs to perform on the data according to the operation code included in the operation request. Different operations have different operation features, and the operation feature may, for example, represent the type of the operation, whether to call the trusted chip to perform an operation, and the like. The corresponding operation feature may be determined according to the operation code in the operation request, and it may be further determined which type of operation is required.

It should be noted that the acquiring module 810 and the determining module 812 correspond to steps S702 to S704 in Example embodiment 4, and examples and application scenarios implemented by the two modules and the corresponding steps are the same, but are not limited to the content disclosed in Example embodiment 4. It should be noted that the above modules may be operated as a part of the apparatus in the computer terminal 10 provided in Example embodiment 2.

According to the solution provided in Example embodiment 5 of the present disclosure, an operation request for operating data may be acquired in real time; after the operation request is acquired, an operation code in the operation request may be extracted, and it may be determined, according to the operation code, to trigger a trusted chip to encrypt a file, thus achieving the purpose of identifying ransomware and preventing the ransomware from operating data.

It is noted that only a valid user who encrypts data through a trusted chip may overwrite or delete the data. Compared with the conventional techniques, data does not need to be backed up, and therefore, it is unnecessary to sacrifice a large amount of storage space to store backup data; moreover, it is unnecessary to maintain a large and comprehensive editor white list, and only few valid users of operable data in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 5 provided in the present disclosure.

### EXAMPLE EMBODIMENT 6

According to the example embodiments of the present disclosure, a file processing system is further provided, including:

a processor; and

a memory connected to the processor and used to provide the processor with an instruction for processing the following processing steps: monitoring an operation request for operating a file; acquiring an operation feature of the operation if the operation request is monitored; and analyzing the operation feature, and determining to trigger a trusted chip to encrypt the file.

According to the solution provided in Example embodiment 6 of the present disclosure, an operation request for operating a file may be monitored in real time; an operation feature of the operation may be acquired when the operation request is monitored; the operation feature is analyzed, and it is determined to trigger a trusted chip to encrypt the file, thus achieving the purpose of identifying ransomware and preventing the ransomware from operating files.

It is noted that only a valid user who encrypts a file through a trusted chip may overwrite or delete the file. Compared with the conventional techniques, files do not need to be backed up, and therefore, it is unnecessary to sacrifice a large amount of storage space to store backup files; moreover, it is unnecessary to maintain a large and comprehensive editor white list, and only few valid users of operable files in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solution in Example embodiment 6 provided in the present disclosure.

### EXAMPLE EMBODIMENT 7

The example embodiments of the present disclosure may provide a computer terminal, which may be any computer terminal device in a computer terminal group. For example, in this example embodiment, the computer terminal may also be replaced with a terminal device such as a mobile terminal.

For example, in this example embodiment, the computer terminal may be located in at least one network device of a plurality of network devices of a computer network.

In this example embodiment, the computer terminal may execute program codes of the following steps in the file processing method: monitoring an operation request for operating a file; acquiring an operation feature of the operation if the operation request is monitored; and analyzing the operation feature, and determining to trigger a trusted chip to encrypt the file.

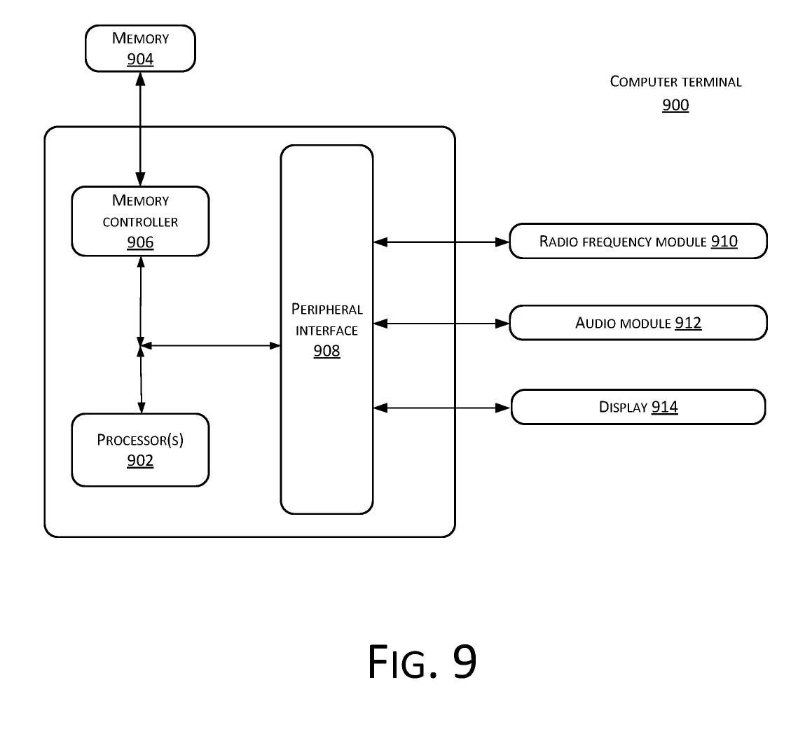

For example, FIG. 9 is a structural block diagram of a computer terminal according to an example embodiment of the present disclosure. As shown in FIG. 9, a computer terminal 900 may include one or more (only one is shown in the figure) processors 902 and a memory 904. The memory 904 communicated with a memory controller 906 that interacts with the processors and a peripherical interface 908. The peripheral interface 908 interacts with a radio frequency module 910, an audio module 912, and a display 914.

The memory 904 may be configured to store software programs and modules, such as the program instructions/modules corresponding to the file processing method and apparatus in the example embodiments of the present disclosure. The processor 902 operates the software programs and modules stored in the memory, thus performing various functional applications and data processing, that is, implementing the above file processing method. The memory 904 may include a high-speed random-access memory and may also include anon-volatile memory, such as one or more magnetic storage apparatuses, a flash memory, or other non-volatile solid-state memories. In some examples, the memory may further include memories disposed remote to the processor. These remote memories may be connected to the terminal A over a network. Examples of the network include, but are not limited to, the Internet, an intranet, a local area network, a mobile communication network, and a combination thereof.

The processor 902 may call, via the transmission apparatus, information and an application program stored in the memory, to perform the following steps: monitoring an operation request for operating a file; acquiring an operation feature of the operation if the operation request is monitored; and analyzing the operation feature, and determining to trigger a trusted chip to encrypt the file.

For example, the processor 902 may further execute program codes of the following steps: determining whether to trigger the trusted chip to perform an encryption operation on the file, wherein the trusted chip is configured to encrypt or decrypt the file by a key stored therein; if the trusted chip is triggered to perform the encryption operation on the file, determining that the trusted chip is triggered to encrypt the file, and performing a step of allowing a valid operation by a valid user on the file; and if the trusted chip is not triggered to perform the encryption operation on the file, determining that the trusted chip is not triggered to encrypt the file, and performing a step of prohibiting the valid operation on the file.

For example, the processor 902 may further execute program codes of the following steps: before determining whether to trigger the trusted chip to encrypt the file, determining whether the operation feature of the operation is an encryption behavior; and if determining that the operation feature belongs to the encryption behavior, determining whether to trigger the trusted chip to encrypt the file.

For example, the processor 902 may further execute program codes of the following steps: acquiring an information entropy of a target file, wherein the target file is a file used for overwriting the file; determining whether the information entropy reaches an encryption threshold; if determining that the information entropy reaches the encryption threshold, determining that the operation feature belongs to the encryption behavior; and if it is determined that the information entropy does not reach the encryption threshold, determining that the operation feature does not belong to the encryption behavior.

For example, the processor 902 may further execute program codes of the following steps: acquiring target content, wherein the target content is content used for overwriting the file; determining whether the target content conforms to an encryption feature; if determining that the target content conforms to the encryption feature, determining that the operation feature belongs to the encryption behavior; and if determining that the target content does not conform to the encryption feature, determining that the operation feature does not belong to the encryption behavior.

For example, the processor 902 may further execute program codes of the following step: when determining that the operation feature does not belong to the encryption behavior, performing the step of allowing the valid operation on the file.

For example, the processor 902 may further execute program codes of the following steps: determining whether the operation is a write operation before determining whether the operation feature is the encryption behavior; if the operation is determined as a write operation, determining whether the operation feature of the operation is the encryption behavior; and if the operation is determined as a read operation, performing a step of allowing the read operation on the file.

For example, the processor 902 may further execute program codes of the following steps: before allowing the valid operation by the valid user on the file, acquiring a password input by the valid user; determining whether the password is correct; if determining that the password is correct, performing the step of allowing a valid operation by a valid user on the file; and if determining that the password is incorrect, performing the step of prohibiting the valid operation on the file.

For example, the processor 902 may further execute program codes of the following steps: before acquiring the password input by the valid user, acquiring a registration request from the valid user; generating a privileged password for the valid user; and receiving a file list sent by the valid user, wherein the operation request is a request for operating a file in the file list.

For example, the processor 902 may further execute program codes of the following steps: before acquiring the registration request from the valid user, acquiring platform certificates from a platform certificate issuing center, wherein the platform certificates include a platform certificate of the valid user and a platform certificate of the file trusted operation monitoring component; and storing the platform certificates in the trusted chip.

By means of the example embodiment of the present disclosure, an operation request for operating a file may be monitored in real time; an operation feature of the operation may be acquired when the operation request is monitored; the operation feature is analyzed, and it is further determined whether to trigger a trusted chip to encrypt the file. If the techniques of the present disclosure determine to trigger the trusted chip to encrypt the file, a valid user is allowed to perform a valid operation on the file, thus achieving the objective of identifying ransomware and preventing the ransomware from operating files.

It is noted that only a valid user who encrypts a file through a trusted chip may overwrite or delete the file. Compared with the conventional techniques, files do not need to be backed up, and therefore, it is unnecessary to sacrifice a large amount of storage space to store backup files; moreover, it is unnecessary to maintain a large and comprehensive editor white list, and only few valid users of operable files in a host need to be managed. In addition, new varieties of the ransomware may be coped with, thus achieving the technical effects of saving storage space, reducing management costs, increasing the processing accuracy, and improving the user experience.

As such, the technical problems of low processing accuracy and high cost of the file processing method in the conventional techniques are solved by the solutions provided in the present disclosure.

Those of ordinary skill in the art may understand that the structure shown in FIG. 9 is merely illustrative, and the computer terminal may also be a smart phone (such as an Android phone and an iOS phone), a tablet computer, a palmtop computer, a Mobile Internet Device (MID), a PAD, and other terminal devices. The structure of the above electronic device is not limited by FIG. 9. For example, the computer terminal A may also include more or fewer components (such as a network interface and a display apparatus) than those shown in FIG. 9, or have a configuration different from that shown in FIG. 9.

Those of ordinary skill in the art may understand that all or part of the steps of the above example embodiments may be implemented by a program instructing hardware related to the terminal device, and the program may be stored in a computer readable storage medium, and the storage medium may include a flash memory, a Read-Only Memory (ROM), a Random-Access Memory (RAM), a magnetic disk, or an optical disc.

### EXAMPLE EMBODIMENT 8

A storage medium is further provided in the example embodiments of the present disclosure. For example, in this example embodiment, the storage medium may be configured to store program codes executed by the file processing method provided in Example embodiment 1.

For example, in this example embodiment, the storage medium may be located in any computer terminal in a computer terminal group in a computer network, or in any mobile terminal in a mobile terminal group.

For example, in this example embodiment, the storage medium is configured to store program codes for performing the following steps: monitoring an operation request for operating a file; acquiring an operation feature of the operation if the operation request is monitored; and analyzing the operation feature, and determining to trigger a trusted chip to encrypt the file.

For example, the storage medium is further configured to store program codes for performing the following steps: determining whether to trigger the trusted chip to perform an encryption operation on the file, wherein the trusted chip is configured to encrypt or decrypt the file by a key stored therein; if the trusted chip is triggered to perform the encryption operation on the file, determining that the trusted chip is triggered to encrypt the file, and performing a step of allowing a valid operation by a valid user on the file; and if the trusted chip is not triggered to perform the encryption operation on the file, determining that the trusted chip is not triggered to encrypt the file, and performing a step of prohibiting the valid operation on the file.

For example, the storage medium is further configured to store program codes for performing the following steps: before determining whether to trigger the trusted chip to encrypt the file, determining whether the operation feature of the operation is an encryption behavior; and if it is determined that the operation feature belongs to the encryption behavior, determining whether to trigger the trusted chip to encrypt the file.

For example, the storage medium is further configured to store program codes for performing the following steps: acquiring an information entropy of a target file, wherein the target file is a file used for overwriting the file; determining whether the information entropy reaches an encryption threshold; if it is determined that the information entropy reaches the encryption threshold, determining that the operation feature belongs to the encryption behavior; and if it is determined that the information entropy does not reach the encryption threshold, determining that the operation feature does not belong to the encryption behavior.

For example, the storage medium is further configured to store program codes for performing the following steps: acquiring target content, wherein the target content is content used for overwriting the file; determining whether the target content conforms to an encryption feature; if it is determined that the target content conforms to the encryption feature, determining that the operation feature belongs to the encryption behavior; and if it is determined that the target content does not conform to the encryption feature, determining that the operation feature does not belong to the encryption behavior.

For example, the storage medium is further configured to store program codes for performing the following step: when it is determined that the operation feature does not belong to the encryption behavior, performing the step of allowing the valid operation on the file.

For example, the storage medium is further configured to store program codes for performing the following steps: before determining whether the operation feature is the encryption behavior, determining whether the operation is a write operation; if the operation is determined as a write operation, determining whether the operation feature of the operation is an encryption behavior; and if the operation is determined as a read operation, performing a step of allowing the read operation on the file.

For example, the storage medium is further configured to store program codes for performing the following steps: before allowing the valid operation by the valid user on the file, acquiring a password input by the valid user; determining whether the password is correct; if it is determined that the password is correct, performing the step of allowing a valid operation by a valid user on the file; and if it is determined that the password is incorrect, performing the step of prohibiting the valid operation on the file.

For example, the storage medium is further configured to store program codes for performing the following steps: before acquiring the password input by the valid user, acquiring a registration request from the valid user; generating a privileged password for the valid user; and receiving a file list sent by the valid user, wherein the operation request is a request for operating a file in the file list.

For example, the storage medium is further configured to store program codes for performing the following steps: before acquiring the registration request from the valid user, acquiring platform certificates from a platform certificate issuing center, wherein the platform certificates include a platform certificate of the valid user and a platform certificate of the file trusted operation monitoring component; and storing the platform certificates in the trusted chip.

The serial numbers of the example embodiments of the present disclosure are merely for description, and do not represent the precedence of the example embodiments.

In the above example embodiments of the present disclosure, the descriptions of the example embodiments have different focuses, and the parts not detailed in a certain example embodiment may be obtained with reference to the related descriptions of other example embodiments.

In the several example embodiments provided by the present disclosure, it should be understood that the disclosed technical content may be implemented in other manners. The apparatus example embodiments described above are merely illustrative. For example, the division of units is only a logical functional division. In actual implementation, there may be other division manners. For example, multiple units or components may be combined or may be integrated into another system, or some features may be ignored or not executed. In addition, the mutual coupling or direct coupling or communication connection shown or discussed may be an indirect coupling or communication connection through some interfaces, units or modules, and may be in an electrical form or other forms.

The units described as separate components may or may not be physically separated, and the components displayed as units may or may not be physical units, that is, they may be located in one place, or may be distributed to multiple network units. Some or all of the units may be selected according to actual needs to achieve the purpose of the solution of the example embodiment.

In addition, various functional units in the example embodiments of the present disclosure may be integrated into one processing unit, or each unit may exist alone physically, or two or more units may be integrated into one unit. The integrated unit may be implemented in the form of hardware or in the form of a software functional unit.

The integrated unit, if implemented in the form of a software functional unit and sold or used as an independent product, may be stored in a computer readable storage medium. Based on such understanding, the technical solution of the present disclosure essentially or the parts contributing to the conventional techniques, or all or part of the technical solution may be embodied in the form of a software product. The computer software product is stored in a storage medium and includes several instructions for enabling a computer device (which may be a personal computer, a server, a network device, or the like) to perform all or some of steps of the methods described in various example embodiments of the present disclosure. The storage medium includes: a USB flash disk, a Read-Only Memory (ROM), a Random-Access Memory (RAM), a removable hard disk, a magnetic disk, an optical disk, or other media capable of storing program codes.

The above descriptions are only preferred example embodiments of the present disclosure, and it should be noted that those of ordinary skill in the art may also make several improvements and embellishments without departing from the principles of the present disclosure, and these improvements and embellishments should be considered as falling in the protection scope of the present disclosure.

The present disclosure may further be understood with clauses as follows.

Clause 1. A file processing method, comprising:

monitoring an operation request for operating a file;

acquiring an operation feature of the operation if the operation request is monitored; and

analyzing the operation feature, and determining to trigger a trusted chip to encrypt the file.

Clause 2. The method of clause 1, wherein the step of analyzing the operation feature, and determining to trigger a trusted chip to encrypt the file comprises:

determining whether to trigger the trusted chip to perform an encryption operation on the file, wherein the trusted chip is configured to encrypt or decrypt the file by a key stored therein,

wherein if the trusted chip is triggered to perform the encryption operation on the file, then it is determined to trigger the trusted chip to encrypt the file, and a step of allowing a valid operation by a valid user on the file is performed; and

if the trusted chip is not triggered to perform the encryption operation on the file, then it is determined that the trusted chip is not triggered to encrypt the file, and a step of prohibiting the valid operation on the file is performed.

Clause 3. The method of clause 2, wherein before the step of determining whether to trigger the trusted chip to encrypt the file, the method further comprises:

determining whether the operation feature of the operation is an encryption behavior; and

determining whether to trigger the trusted chip to encrypt the file if it is determined that the operation feature belongs to the encryption behavior.

Clause 4. The method of clause 3, wherein the step of determining whether the operation feature of the operation is an encryption behavior comprises:

acquiring an information entropy of a target file, wherein the target file is a file used for overwriting the file;

determining whether the information entropy reaches an encryption threshold;

determining that the operation feature belongs to the encryption behavior if it is determined that the information entropy reaches the encryption threshold; and

determining that the operation feature does not belong to the encryption behavior if it is determined that the information entropy does not reach the encryption threshold.

Clause 5. The method of clause 3, wherein the step of determining whether the operation feature of the operation is an encryption behavior comprises:

acquiring target content, wherein the target content is content used for overwriting the file;

determining whether the target content conforms to an encryption feature;

determining that the operation feature belongs to the encryption behavior if it is determined that the target content conforms to the encryption feature; and

determining that the operation feature does not belong to the encryption behavior if it is determined that the target content does not conform to the encryption feature.

Clause 6. The method of clause 3, wherein the step of allowing the valid operation on the file is performed when it is determined that the operation feature does not belong to the encryption behavior.

Clause 7. The method of clause 3, wherein before the step of determining whether the operation feature of the operation is an encryption behavior, the method further comprises:

determining whether the operation is a write operation;

determining whether the operation feature of the operation is the encryption behavior if the operation is determined as the write operation; and

performing a step of allowing a read operation on the file if the operation is determined as the read operation.

Clause 8. The method of clause 2, wherein before the step of allowing a valid operation by a valid user on the file, the method further comprises:

acquiring a password input by the valid user;

determining whether the password is correct;

performing the step of allowing a valid operation by a valid user on the file if it is determined that the password is correct; and

performing the step of prohibiting the valid operation on the file if it is determined that the password is incorrect.

Clause 9. The method of clause 8, wherein before the step of acquiring a password input by the valid user, the method further comprises:

acquiring a registration request from the valid user;

generating a privileged password for the valid user; and

receiving a file list sent by the valid user, wherein the operation request is a request for operating a file in the file list.

Clause 10. The method of clause 9, wherein before the step of acquiring a registration request from the valid user, the method further comprises:

acquiring platform certificates from a platform certificate issuing center, wherein the platform certificates comprise a platform certificate of the valid user and a platform certificate of a file trusted operation monitoring component; and

storing the platform certificates in the trusted chip.

Clause 11. A file processing system, comprising:

a file trusted operation monitoring component configured to monitor an operation request for operating a file, and acquire an operation feature of the operation if the operation request is monitored; and

a trusted chip configured to encrypt the file, wherein

the file trusted operation monitoring component is in communication with the trusted chip and is further configured to analyze the operation feature and determine to trigger the trusted chip to encrypt the file.

Clause 12. A storage medium, the storage medium comprising a stored program, wherein during running of the program, a device where the storage medium is located is controlled to perform the following steps: monitoring an operation request for operating a file; acquiring an operation feature of the operation if the operation request is monitored; and analyzing the operation feature, and determining to trigger a trusted chip to encrypt the file.

Clause 13. A processor, configured to run a program, wherein during running of the program, the following steps are performed: monitoring an operation request for operating a file; acquiring an operation feature of the operation if the operation request is monitored; and analyzing the operation feature, and determining to trigger a trusted chip to encrypt the file.

Clause 14. A file processing system, comprising:

a processor; and

a memory connected to the processor and used to provide the processor with an instruction for processing the following processing steps: monitoring an operation request for operating a file; acquiring an operation feature of the operation if the operation request is monitored; and analyzing the operation feature, and determining to trigger a trusted chip to encrypt the file.

Clause 15. A data processing method, comprising:

acquiring an operation request for operating data, wherein the operation request comprises an operation code; and

determining, according to the operation code, to trigger a trusted.

What is claimed is:

1. A method comprising:
monitoring an operation request for operating a file;
acquiring an operation feature of the operation; and
analyzing the operation feature to determine to trigger a trusted chip to encrypt the file.

2. The method of claim 1, wherein the analyzing the operation feature to determine to trigger the trusted chip to encrypt the file comprises:
determining whether to trigger the trusted chip to perform an encryption operation on the file, wherein the trusted chip is configured to encrypt or decrypt the file by a key stored therein; and
in response to determining that the trusted chip is triggered to perform the encryption operation on the file, triggering the trusted chip to encrypt the file and allowing a valid operation on the file.

3. The method of claim 1, wherein the analyzing the operation feature to determine to trigger the trusted chip to encrypt the file comprises:
determining whether to trigger the trusted chip to perform an encryption operation on the file, wherein the trusted chip is configured to encrypt or decrypt the file by a key stored therein; and
in response to determining that the trusted chip is not triggered to perform the encryption operation on the file, determining that the trusted chip is not triggered to encrypt the file and prohibiting a valid operation on the file.

4. The method of claim 3, wherein before the determining whether to trigger the trusted chip to encrypt the file, the method further comprises:
determining whether the operation feature of the operation is an encryption behavior.

5. The method of claim 4, wherein the determining whether the operation feature of the operation is the encryption behavior comprises:
acquiring an information entropy of a target file, wherein the target file is a file used for overwriting the file;
determining whether the information entropy reaches an encryption threshold; and
determining that the operation feature belongs to the encryption behavior in response to determining that the information entropy reaches the encryption threshold.

6. The method of claim 4, wherein the determining whether the operation feature of the operation is the encryption behavior comprises:
acquiring an information entropy of a target file, wherein the target file is a file used for overwriting the file;
determining whether the information entropy reaches an encryption threshold; and
determining that the operation feature does not belong to the encryption behavior in response to determining that the information entropy does not reach the encryption threshold.

7. The method of claim 4, wherein the determining whether the operation feature of the operation is the encryption behavior comprises:
acquiring a target content, wherein the target content is content used for overwriting the file;
determining whether the target content conforms to an encryption feature; and
determining that the operation feature belongs to the encryption behavior in response to determining that the target content conforms to the encryption feature.

8. The method of claim 4, wherein the determining whether the operation feature of the operation is the encryption behavior comprises:
acquiring a target content, wherein the target content is content used for overwriting the file;
determining whether the target content conforms to an encryption feature; and
determining that the operation feature does not belong to the encryption behavior in response to determining that the target content does not conform to the encryption feature.

9. The method of claim 4, further comprising:
determining that the operation feature does not belong to the encryption behavior; and
allowing the valid operation on the file.

10. The method of claim 4, wherein before the determining whether the operation feature of the operation is the encryption behavior, the method further comprises:
determining whether the operation is a write operation; and
determining whether the operation feature of the operation is the encryption behavior in response to determining that the operation is the write operation.

11. The method of claim 4, wherein before the determining whether the operation feature of the operation is the encryption behavior, the method further comprises:
determining that the operation is a read operation; and
allowing the read operation on the file.

12. The method of claim 2, wherein before the allowing the valid operation on the file, the method further comprises:
acquiring a password input by a valid user;
determining that the password is correct; and
allowing the valid operation by the valid user on the file.

13. The method of claim 2, wherein before the allowing the valid operation on the file, the method further comprises:
acquiring a password input by a valid user;
determining that the password is incorrect; and
prohibiting the valid operation on the file.

14. The method of claim 13, wherein before the acquiring the password input by the valid user, the method further comprises:
acquiring a registration request from the valid user;
generating a privileged password for the valid user; and
receiving a file list sent by the valid user, wherein the operation request is a request for operating the file in the file list.

15. The method of claim 14, wherein before the acquiring the registration request from the valid user, the method further comprises:
acquiring platform certificates from a platform certificate issuing center, wherein the platform certificates comprise a platform certificate of the valid user and a platform certificate of a file trusted operation monitoring component; and
storing the platform certificates in the trusted chip.

16. A system comprising:
a file trusted operation monitoring component configured to monitor an operation request for operating a file, and acquire an operation feature of the operation in response to determining that the operation request is monitored; and
a trusted chip configured to encrypt the file.

17. The system of claim 16, wherein:
the file trusted operation monitoring component communicates with the trusted chip, analyzes the operation feature and determines to trigger the trusted chip to encrypt the file.

18. One or more memories stored thereon computer readable instructions that, when executed by one or more processors, cause the one or more processors to perform acts comprising:
monitoring an operation request for operating a file;
acquiring an operation feature of the operation; and
analyzing the operation feature to determine to trigger a trusted chip to encrypt the file.

19. The one or more memories of claim 18, wherein the analyzing the operation feature to determine to trigger the trusted chip to encrypt the file comprises:
determining whether to trigger the trusted chip to perform an encryption operation on the file, wherein the trusted chip is configured to encrypt or decrypt the file by a key stored therein; and
in response to determining that the trusted chip is triggered to perform the encryption operation on the file, triggering the trusted chip to encrypt the file and allowing a valid operation on the file; or
in response to determining that the trusted chip is not triggered to perform the encryption operation on the file, determining that the trusted chip is not triggered to encrypt the file and prohibiting a valid operation on the file.

20. The one or more memories of claim 19, wherein:
before the determining whether to trigger the trusted chip to encrypt the file, the acts further comprise:
determining whether the operation feature of the operation is an encryption behavior, the determining comprising:
acquiring an information entropy of a target file, wherein the target file is a file used for overwriting the file; and
determining whether the information entropy reaches an encryption threshold;
determining that the operation feature belongs to the encryption behavior in response to determining that the information entropy reaches the encryption threshold; or
determining that the operation feature does not belong to the encryption behavior in response to determining that the information entropy does not reach the encryption threshold.
